(19) United States
(12) Patent Application Publication
(10) Pub. No.: US 2021/0314698 A1
(43) Pub. Date: Oct. 7, 2021

(54) EARPHONE DEVICE

(71) Applicant: Amnon SHIRI, Petach Tikva (IL)

(72) Inventor: Amnon SHIRI, Petach Tikva (IL)

(21) Appl. No.: 17/221,829

(22) Filed: Apr. 4, 2021

Related U.S. Application Data
(60) Provisional application No. 63/005,481, filed on Apr. 6, 2020.

(51) Int. Cl. H04R 1/10; H04R 3/00; G02C 11/00

(52) U.S. Cl. CPC H04R 1/1066; G02C 11/10; H04R 3/00

(57) ABSTRACT

An apparatus detachably connected to a temple of spectacles and designed for receiving audio signals, converting the receiving audio signals into a corresponding sound, and thus allowing a user wearing the spectacles to hear the converted sound. The apparatus can comprise a connector comprising two walls positioned opposite to each other, said walls comprising one or more modules designed to securely connect the walls to a temple of spectacles. The apparatus also comprises a metallic house designed for housing electrical circuitry designed to convert a received electrical audio signal into a corresponding sound. The metallic house can be coupled to the connector in a detachable fashion, thus allowing a user wearing said spectacles to hear the converted sound.

### CROSS REFERENCE TO RELATED APPLICATIONS

This application claims the benefit of priority of U.S. Provisional Patent Application No. 63/005,481, filed Apr. 6, 2020, the contents of which are all incorporated herein by reference in their entirety.

### FIELD OF THE INVENTION

The present invention relates to the field of wireless earphones adapted for carrying and portability.

### BACKGROUND OF THE INVENTION

Consumers use earphone for enjoying music, audio books, using telephone devices, podcasts, or other types of media in a variety of different situations throughout the day. During the day, earphone and/or headphone convenience of carrying such as ease and flexibility may be desirable.

Earphones can be adapted to receive sound signals via cables or via wireless communication, e.g., via blue-tooth techniques, for the purpose of communication with portable devices such as mobile telephones, computing devices, e.g., laptop or personal computer, and the like.

Common earphones are adapted to be carried on the person ear which is not convenient and sometimes restrictive in terms of a person's flexibility of movement. Furthermore, earphones are sold as standalone products, e.g., Apple's brand “AirPods” which communicate with Apple's products. Persons using such standalone earphone products carry the earphones on their ears, which is inconvenient, not sterile and changes the natural appearance of a person's face by expanding the ear's size and appearance. Thus, there is a need for a new design of wireless earphones.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

There is provided, in accordance with an embodiment, an apparatus, comprising: a connector comprising two walls positioned opposite to each other, said walls comprising one or more modules designed to securely connect the walls to a temple of spectacles, a metallic house housing electrical circuitry comprising a non-transitory computer-readable storage medium having stored thereon program code, the program code executable by the at least one hardware processor to convert a received electrical audio signal into a corresponding sound, at least one connecting unit embedded into one of the connector walls, said unit is adapted to couple the metallic house to the connector in a detachable fashion, thus allowing a user wearing said spectacles to hear the converted sound.

In one aspect of the disclosed apparatus, the electrical circuitry further comprises program code utilized for determining whether said house is in close proximity to said user.

In one aspect of the disclosed apparatus, determining whether the house is in close proximity to the user is done, at least in part, by using one or more parameters of the group consisting of: ambient temperature, accelerating parameters of the user, skin temperature of the user, tone of a user, spatial position of a detected object, spatial three-axis position of the detected object, noise, and sound.

In one aspect of the disclosed apparatus, the connecting unit comprises magnet unit configured to attract the metallic house.

In one aspect of the disclosed apparatus, the electrical circuitry is configured to communicate with a computerized device for receiving the electrical audio signal.

In one aspect of the disclosed apparatus, the electrical circuitry is configured for activate or deactivate the communication with the computerized device.

In one aspect of the disclosed apparatus, the electrical circuitry is configured for activate or deactivate the communication with the computerized device according to one or more predefined words.

In one aspect of the disclosed apparatus, the connector comprises a fastening mechanism for fastening the connector to the temple.

In one aspect of the disclosed apparatus, the fastening mechanism is at least two magnet modules each of which is connected to one of said wall, and wherein polarization of both magnetic modules is configured to attract the two magnetic modules to each other.

In addition to the exemplary aspects and embodiments described above, further aspects and embodiments will become apparent by reference to the figures and by study of the following detailed description.

### BRIEF DESCRIPTION OF THE FIGURES

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced. In the drawings:

FIG. 1 discloses spectacles having a connector placed on one of the spectacles' temples, according to exemplary embodiments of the present invention;

FIG. 2A discloses spectacles having a connector and electrical circuitry placed on one of the spectacles' temples with a control knob, according to exemplary embodiments of the present invention;

FIG. 2B shows a left temple of spectacles having a connector and electrical circuitry placed on one of the spectacles' temples, according to exemplary embodiments of the present invention;

FIG. 3A discloses a side view of a connector configured to be placed on one of the spectacles' temples, according to exemplary embodiments of the present invention;

FIG. 3B discloses a connector configured to be placed on one of the spectacles' temples, according to exemplary embodiments of the present invention;

FIG. 3C discloses a front view of a connector configured to be placed on one of the spectacles' temples, according to exemplary embodiments of the present invention; and,

FIG. 4 which is a schematic depiction of a system comprising possible electrical components of the electrical circuitry of the earphone apparatus, according to exemplary embodiments of the present invention.

### DETAILED DESCRIPTION OF THE INVENTION

Disclosed herein and apparatus designed to be detachably connected to a temple of spectacles and for receiving audio signals, converting the receiving audio signals into a corresponding sound, and thus allowing a user wearing the spectacles to hear the converted sound.

In some embodiments, the present disclosure provides for enabling a user wearing spectacles to use an earing device, e.g., earphone, to attach the earing device to the temples of the spectacles in a detachably fashion in easy manner, e.g., by the fingertips.

In some embodiments, the present disclosure provides for utilizing an earing apparatus by employing at least one connector adapted for mounting to the temple of the spectacles. In some embodiments, each connector comprises two walls positioned opposite to each other, e.g., U-shaped connector designed to be pressed upon the temple.

The term “temples” used herein are the elongated part of the spectacles extending from the frame towards the person's ears. In some embodiments, the cross section of the temples may be elliptical, polygonal or a combination thereof.

In some embodiments, the present discloser provides for utilizing a wireless earphone apparatus configured to be secured to spectacles. In some embodiments, the apparatus comprises a pair of connectors, each connector of the pair is configured to be secured to one of the temples.

In some embodiments, the connector is configured to be secured to the temples, such that the connector is removed from the temples or along the temples when the user actively removes the connector, not due to change in the angle of the temple relative to the ground.

In some embodiments, the present disclosure also provides for using a metallic house housing electrical circuitry comprises electrical components designed to convert a received electrical audio signal into a corresponding sound.

In some embodiments, the metallic house can be attached, e.g., by a magnetic unit, to the connector. In some embodiments, two metallic houses can be utilized, each metallic house can be attached to one connector.

In some embodiments, electrical circuitry comprises a wireless communication module, for example a Bluetooth receiver. The electrical circuitry may comprise an audio receiver, e.g., a transducer such as a microphone, for receiving audio signals.

The term “audio signals” used inhere refer to signals representing sound. The signals can be electrical voltage for analog signals or binary numbers for digital signals. In some embodiments, the present disclosure provides for receiving such audio signals from a computing device such as personal computer, laptop, mobile telephone device or any communication device designed to transmit audio signals over computer network that interconnects computerized device.

In some embodiments, the electrical circuitry may comprise one or more processing module/units for controlling the operation of the electrical components included in the electrical circuitry. The electrical circuitry may also comprise a sensor module for collecting one or more measurements of the ambient parameters. In some embodiments, such ambient parameters are used by the electrical circuitry or one of the components thereof to determine whether the apparatus disclosed herein is at the proximity of the user wearing the spectacles, as elaborated further below.

In some embodiments, the apparatus comprises a pair of connectors, each connector of the pair is secured to one temple of the spectacles. The apparatus also comprises a pair of houses, each of which comprises the electrical circuitry and is secured to one connector of the pair of connectors, near one of the user's ears. In some embodiments, the house are placed near the user's ears, providing audio signals thereto. In some embodiments, the audio signals are received from a remote electrical device connected to the electrical circuitry, such as a cellular phone, tablet, laptop, personal computer and the like.

In some embodiments, the electrical circuitry can further comprise a microphone and/or speaker component in operable communication with a processing unit of the electrical circuitry, and being configured or configurable to receive and/or provide an audio signal.

Accordingly, in some embodiments, the present disclosure provides for receiving audio signals from a computerized device, e.g., mobile telephone, by the electrical circuitry, and the electrical circuitry can convert the audio signals to sound hearable by the user wearing the spectacles.

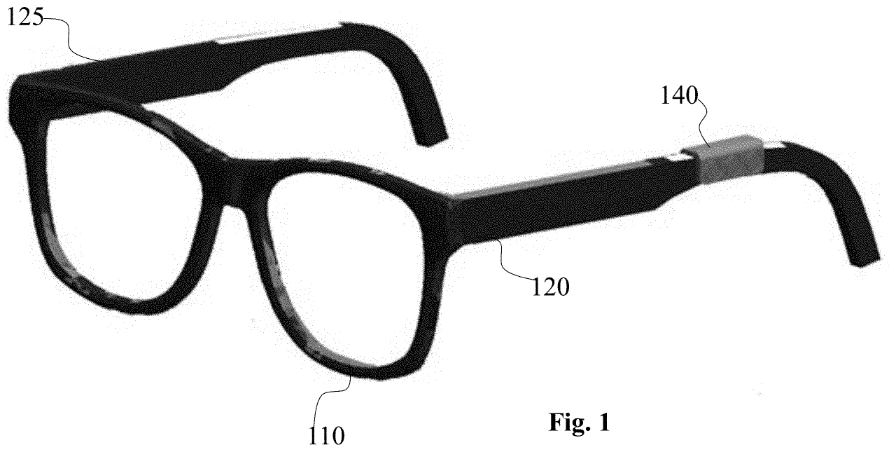

A refence is made to FIG. 1 disclosing spectacles having a connector placed on one of the spectacles' temples, according to exemplary embodiments of the present invention. The spectacles comprise a frame front 110 which secures the lenses and temples 120, 125 mounted on the user's ears. The shape and size of the frame front 110 and temples 120, 125 may vary according to the design of the spectacles. Regardless of the shape and size, the temples 120, 125 extend rearwardly from the frame front 110, towards the user's ears. The connector 140 is mounted in the rear side of the temple 120, relatively close to the person's left ear. The distance between the connector and the person's ear may be in the range of 0.5-2 centimeters.

In some embodiments, the connector 140 is designed to be to securely connected to the temple 120. In some embodiments, such securely manner, or secure is in a manner preventing the connector 140 from sliding on the temple 120. For example, a friction coefficient between inner surfaces of the connector 140 and the external surface of the temple 120 may be higher than a predefined value, preventing the connector 140 from sliding along the connector 140, for example when the person leans downwards. The connector 140 may be removed when a user of the device removes the device. In some cases, removal of the connector 140 may be performed by moving a knob, a pin, a switch, a hook or any other securing mechanism which fastens the connector 140 to the temple 120.

In some embodiments, such securely manner, or secured, is in a manner preventing from the connector 140 to rotate or change position relative to the original position upon temple 120.

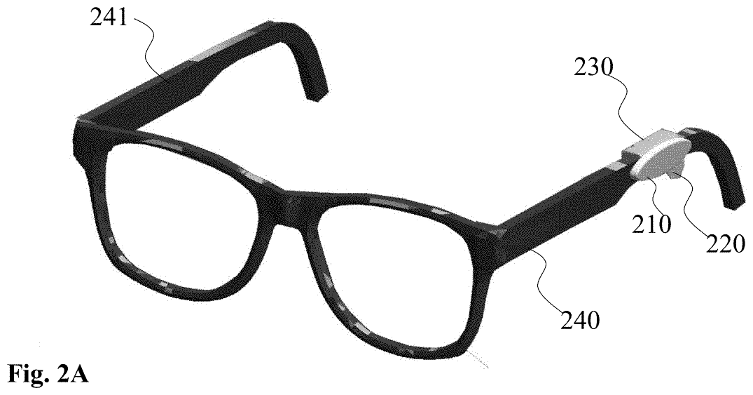

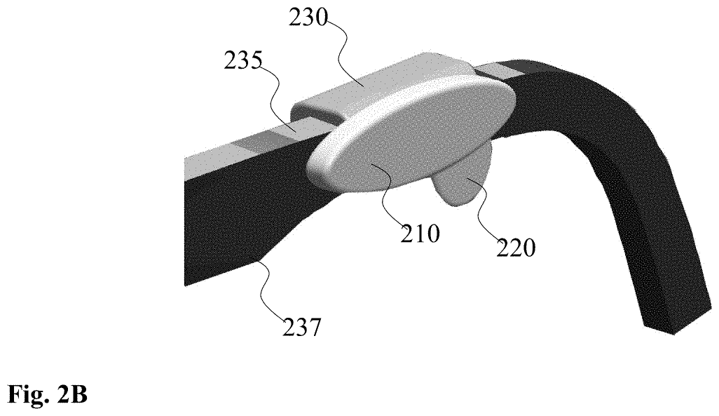

A reference is made to FIG. 2A disclosing spectacles having a connector and electrical circuitry placed on one of the spectacles' temples, according to exemplary embodiments of the present invention. The connector 230 may be secured to the temples 240 using a fastening mechanism as elaborated above. In some embodiments, fastening mechanism verifies that the connector is secure to the temple, e.g., does not slide on the temple, for example towards the frame front as the connector and the earphones, should remain in a fixed distance from the user's ears, to maintain a level of quality of signal provided to the user.

In some embodiments, the electrical circuitry is housed in house 210 secured to the connector 230. The connector 230 is used to secure to the house 210 to the temple 240. This way, the house 210 may be removed from the connector 230, for example for recharging or replacing the electrical components of the house 210, while the connector 230 remains secured to the temple 240. In some embodiments, the connector 210 lacks any electrical components that need charging, only mechanical components for securing the connector 230 to the temple 240 and to the house 210.

In some embodiments, the house 210 may be placed next to an external side of the connector 230. That is, one house is secured to the left side of the connector secured to the left temple and another house is secured to the right side of the connector secured to the right temple.

In some embodiments, one house such as 210 connected to temple 240 can receive audio signals, as aforementioned and communicate with another housing (not shown) connected to the temple 241. In some embodiments, such a communication between housings is used for playing stereophonic sound.

A reference is made to FIG. 2B showing a left temple of spectacles having a connector and electrical circuitry placed on one of the spectacles' temples with a control knob, according to exemplary embodiments of the present invention. FIG. 2B shows a house 210 mounted on a left temple 237 of spectacles (not shown). The house 210 comprises a knob 220.

The center part of the connector 230 is located above an upper surface 235 of the left temple. The house 210 is located left relative to the left temple.

In some embodiments, the control knob 220 is mechanically coupled to the electrical circuitry inside the house 210. Thus, moving the control knob 220 may change the functionality of the electrical circuitry inside the house 210, for example activate the earphones, deactivate the earphones, adjust the volume in which the audio signal is outputted by the earphone, move from one phone call to another and the like.

In some embodiments, the control knob 220 may be maneuvered by pressing the control knob 220 towards the inner volume of the house 210. In some embodiments, the control knob 220 may be moved rotationally around its axis, or circularly, relative to an imaginary point which serves as a center of the circle. The control knob 220 may be below the house 210. The length of the control knob may be 5-25 millimeters.

In some embodiments, the house 210 is configured to generate and conduct sound to the user wearing the spectacles, according to received audio signals received from a computerized device, as aforementioned. Exemplary embodiments of the present disclosure employ diverse techniques for conducting sound to the user.

Accordingly, in some embodiments, such techniques can be using a transducer, e.g., a speaker, converting electrical audio signal into a corresponding sound. In some embodiments, such techniques can be bone conduction for conducting sound to the inner ear primarily through the bones of the skull.

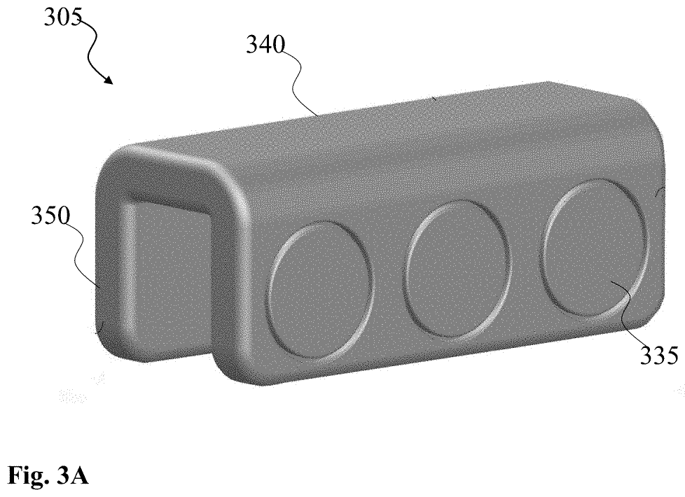

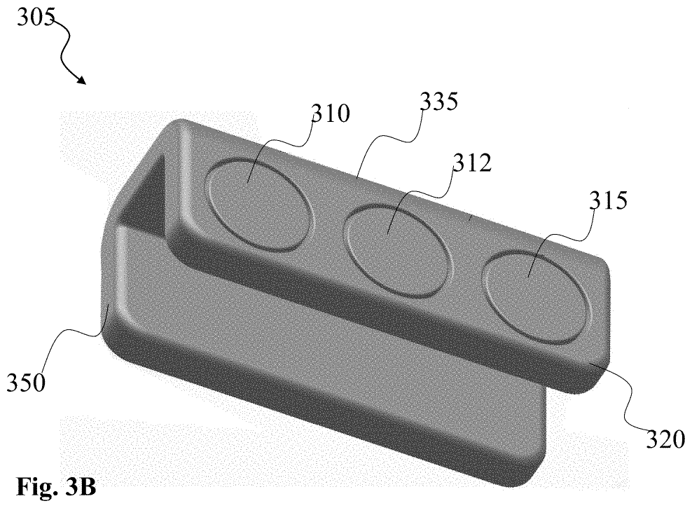

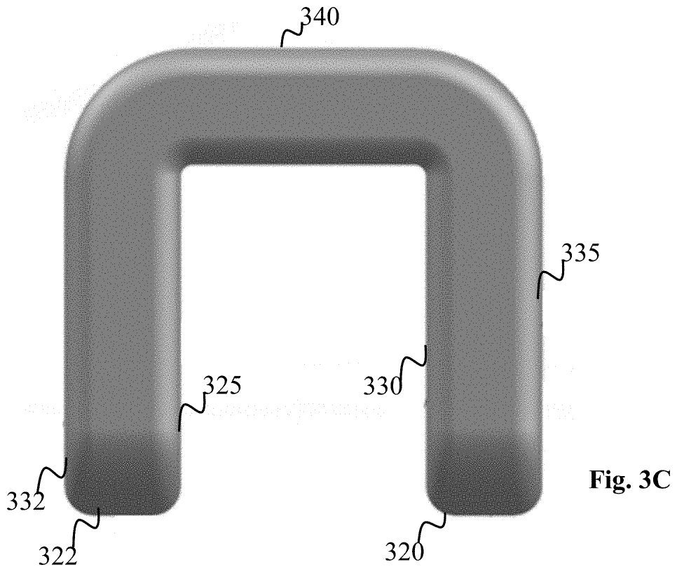

A reference is made to FIG. 3A disclosing a side view of a connector configured to be placed on one of the spectacles' temples, according to exemplary embodiments of the present invention. FIG. 3A shows a connector 305 adapted to be mounted or connected to a temple (not shown).

In some embodiments, the cross section of the connector 305 may be of a polygonal shape as shown in FIGS. 3A-3B or of an elliptical shape. In some embodiments, the connector 305 is configured to be fastened around at least 120 degrees of the cross section of a temple. In some cases, the cross section of the connector comprises three (3) walls, internal wall (not shown), top wall 340 and external wall 335. In some embodiments, a void in the bottom side of the connector enables the user to place the connector onto the temple in a downward movement.

In some embodiments, the connector 305 is arranged to slide over the temple once a threshold force has been applied, e.g., downwards, to the top wall 340. In some embodiments, the internal wall comprises protuberances designed to maintain the position of the connector 305 in a secured and stable manner. Namely, in a manner preventing from connector 305 to move, rotate or change position on the temple, as aforementioned.

In some embodiments, the connector 305 comprises a fastening mechanism for fastening the connector to the temple. Such fastening mechanism may be a pin secured to an aperture, hooks and loops, magnets and the like. In the exemplary embodiment shown in FIGS. 3A-3B, the connector comprises two magnetic modules, one magnetic module in the internal wall and the other magnetic module in the external wall 335. The polarization of both magnetic modules is configured to attract the two magnetic modules to each other, such that the internal wall and the external wall 335 are attracted towards the temple, thereby fastened to the temple.

In some embodiments, the connector can be made of plastic which can be formed by injection and/or molding techniques. In some embodiments, such a plastic is wide range of synthetic or semi-synthetic materials that use polymers as a main ingredient.

A reference is made to FIG. 3B disclosing a connector configured to be placed on one of the spectacles' temples, according to exemplary embodiments of the present invention. FIG. 3B shows a connector 305 comprises external wall 335 and bottom surfaces 322, 320.

In some embodiments, the magnetic module of the external wall 335 comprises 3 magnetic units 310, 312 and 315, which attract the magnetic unit of the internal wall (now shown). The magnetic units 310, 312 and 315 may also attract the house of the electrical circuitry, in case the house comprises metallic materials.

Front surface 350 of the connector points towards the frame front of the spectacles. Bottom surfaces 322, 320 are the bottom-most parts of the internal wall and the external wall, respectively.

In some embodiments, the magnetic units 310, 312 and 315 are embedded in the external wall 335. In some embodiments, the magnetic units 310, 312 and 315 are glued or fastened with adhesive material.

A reference is made to FIG. 3C disclosing a front view of a connector configured to be placed on one of the spectacles' temples, according to exemplary embodiments of the present invention. The front view shows two bottom surfaces 322, 320 which are the bottom-most parts of the internal wall and the external wall. The external wall has an external surface 335 and an internal surface 330. The internal wall has internal surface 325 and external surface 320 positioned opposite to each other. In some embodiments, the internal surfaces 325 and 330 are configured to be in physical contact with the spectacles' temples. The top surface 340 of the top wall is the uppermost point of the connector. The external surface 335 of the external wall may be the surface to which the house is secured.

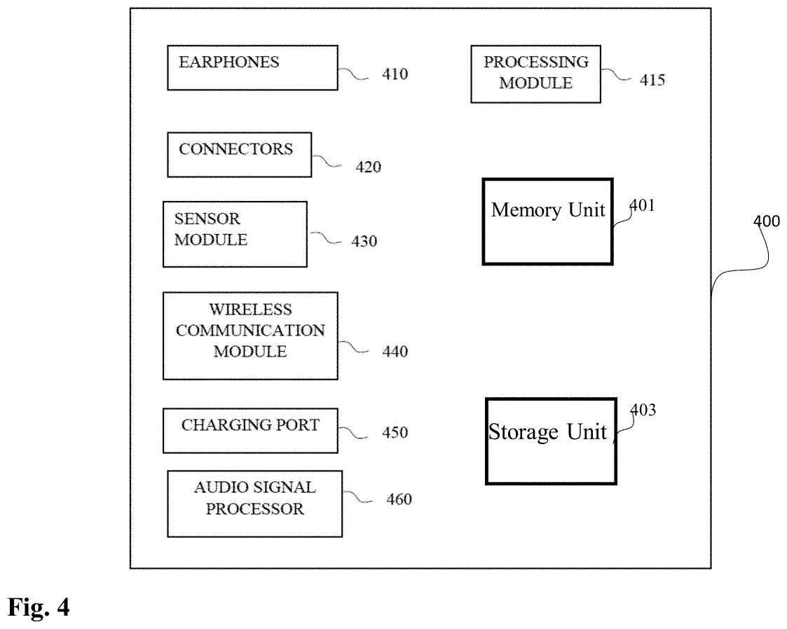

A reference is made to FIG. 4 which is a schematic depiction of a system comprising possible electrical components of the electrical circuitry of the earphone apparatus, according to exemplary embodiments of the present invention. FIG. 4 shows a system 400. System 400 as described herein is only an exemplary embodiment of the present invention, and in practice may have more or fewer components than shown, may combine two or more of the components, or a may have a different configuration or arrangement of the components. The various components of system 400 may be implemented in hardware, software, or a combination of both hardware and software.

In some embodiments, system 400 may store in a non-volatile memory medium thereof, such as storage system 403, software instructions or components configured to operate a processing unit (also “hardware processor,” “CPU,” or simply “processor”), such as processing module 415. In some embodiments, the software components may include an operating system, or embedded instructions, including various software components and/or drivers for controlling and managing general system tasks (e.g., memory management, storage system control, power management, etc.) and facilitating communication between various hardware and software components.

In some embodiments, the storage system 403 is a non-transitory computer-readable storage medium having stored thereon program code, the program code executable by the at least one hardware processor such as processing unit 415, and/or sensor module 430, or any processing unit utilized by system 400.

In some embodiments, system 400 and/or the electrical circuitry thereof comprises earphones 410. The earphones 410 comprise a medium for outputting the audio signals to a user. Such medium may function as a speaker, for example by vibrating based on the audio signal. The earphones 410 are electrically coupled to a wireless communication module 440. The wireless communication module 440 exchanges signals with a remote electronic device, such as a cellular phone, tablet, laptop, and the like. The signals may be audio signals and commands, such as hopping from one phone call to another.

The wireless communication module 440 comprises a wireless receiver for receiving signals over wireless medium. The wireless receiver may be configured to receive signals sent via a blue-tooth technique. The signals received by the wireless communication module 440 may be stored in a memory address in a memory unit such as memory unit 401, of the electrical circuitry. The stored signals may be processed by an audio signal processor 460. Processing the audio signals may be performed using a True Wireless Stereo (TWS) technology.

The electrical circuitry comprises a charging port 450 used for charging a battery of the earphone apparatus. The battery provides electrical current to the electrical components of the electrical circuitry. The charging port 450 is configured to be connected to a charger, and receive electrical current from the charger.

The electrical circuitry comprises a pair of connectors 420 fastened around at least a portion of the cross section of the temples. Each of the connectors 420 comprises a first fastening mechanism for connecting the connectors 420 to the temples. Each of the connectors 420 comprises a second fastening mechanism for connecting the connectors 420 to the house of the electrical circuitry.

In some embodiments, the second fastening mechanism may be located in an external wall of the connectors 420 and may comprise magnetic units configured to attract a surface of the house which comprises metallic materials. In some exemplary cases, the connectors 420 comprise a single fastening mechanism which functions to secure the house of the electrical circuitry and to secure both walls of the connectors 420 around the temple. In some embodiments, such single fastening mechanism may be magnetic units located in both the internal wall and the external wall of the connectors 420. The two sets of magnetic units attract each other, such that the internal wall and the external wall are attracted to each other. In some cases, the magnetic units are located in the bottom side of the internal wall and the external wall, and the height of the internal wall and the external wall is larger than a standard height of a temple, for example 8-15 millimeters, to fasten the internal wall and the external wall together below the temple.

The electrical circuitry of system 400 may comprise a sensor module 430 for collecting ambient parameters p from the vicinity of the house. Such ambient parameters may be such as the temperature near the external surface of the internal wall of the house, which is in physical contact or in close proximity with the user's skin. The collected temperature may then be sampled by the sensor module 430 and sent to the processing module 415. The processing module then determines whether or not the measured temperature indicates that the house is in close proximity with the user's ear. In cases the house is not close to the user's ears, the processing module sends a command via the communication module 440 to the remote device, to output the audio signal by the remote device, and to stop sending the audio to be outputted by the earphones 420.

In some embodiments, the memory unit 401 comprises computer instruction designed to be executed by the processing module 415. In some embodiments, such computer instructions are executed to determine whether the house of the system 400 is in close proximity to the user. For example, the ambient parameters and the measured temperature sampled by the sensor module 430 can be utilized for determining whether the house the system 400 is in a close proximity to the user. In some embodiments, a close proximity can be determined according to one or more threshold values, preconfigured in the system 400 or in any of the components thereof.

In some other cases, the sensor module may be an image sensor that captures images of the house's the immediate surroundings, such that the processing module 415 may determine whether or not the house is located near the user's ears. In some other cases, other or additional parameters are used by the sensor module 430 and/or processing unit 415 to for determining whether the house is in a proximity to the user. In some embodiments, such parameters accelerating value, which may be an accelerometer (not shown), which detects movements of the house. For example. in case there is no movement for more than 20 seconds, it is likely that the house is not placed on the user's body.

In some embodiments, system 400 is configured to detect an object and determine whether the detected object the head of a user. In some embodiments, sending radio waves, or electromagnetic waves, e.g., Infra-Red are used to detect the spatial position of the detected object. In some embodiments, the system also defines the location of the object in a three-dimensional manner in respect to the connector direction. For example, the object detection processes can define the direction to the object, e.g., azimuth, and a spatial three-axis position defining the length, width, and height of the object.

In some embodiments, utilizing ambient parameters such as temperature can assist in the process of determining whether the detected object is a head of a user.

In some embodiments, the object detection processes may employ diverse techniques from the field of spatial analysis, to analyze the information comprising the spatial position and the location of the object. In some embodiments, such an information can be provided or concluded from/by a camera configured to image, at least part of the detected object.

In some embodiments, some object detection processes conducted by the system 400 may be based, at least in part, on using computer vision techniques to identify the spatial position of the detected object. In some embodiments, additional techniques and calculation may be employed to facilitate the obstacle detection process. For example, measuring the size of the detected object and utilizing ambient parameters as aforementioned, for determining whether the detected object is a head of a user.

In some exemplary cases, the electrical circuitry may comprise an audio receiver, such as a microphone, for collecting audio in the vicinity of the house. Such audio may be the user's tone. The processing module 415 may identify a specific tone associated with the user of the earphone apparatus. Responsive to identifying the user, the processing module may activate or deactivate the earphones 410.

In some embodiments, activate the earphones 410 involves connecting with a device such a computerized device for receiving audio signals and deactivate the earphones 410 involves disconnecting with the computerized device for the purposes of receiving audio signals. In some embodiments, in cases the earphones 410 is deactivated, the earphones 410 can communicate with the computerized device for other purposes but receiving audio signal.

In some other cases, the remote device, such as cellular phone communicating with the wireless communication module 440, may identify the user's voice and start exchanging the audio with the wireless communication module 440. In some exemplary cases, the memory unit in the electrical circuitry or in the remote device communicating with the wireless communication module 440 may store predefined words or audio patterns, e.g., “HELLO” or “HI THERE” and when identifying the predefined words and the user's voice, activate or deactivate the communication between the remote device, e.g., a computerized device, and the wireless communication module 440.

The subject matter may also disclose a computerized software application operating in the remote device communicating with the wireless communication module 440. Such computerized software application may be a mobile application running on a cellular phone. The user of the earphone apparatus may input information into the mobile application, such as the audio pattern used to activate or deactivate the communication with the earphone. The user may input additional settings, such as the volume of the audio outputted by the earphones and the like. The information inputted by the user into the mobile application may be sent to the electrical circuitry via the wireless communication module 440.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

What is claimed is:

1. An apparatus, comprising:
a connector comprising two walls positioned opposite to each other, said walls comprising one or more modules designed to securely connect the walls to a temple of spectacles;
a metallic house housing electrical circuitry comprising a non-transitory computer-readable storage medium having stored thereon program code, the program code executable by the at least one hardware processor to convert a received electrical audio signal into a corresponding sound;
at least one connecting unit embedded into one of the connector walls, said unit is adapted to couple the metallic house to the connector in a detachable fashion, thus allowing a user wearing said spectacles to hear the converted sound.

2. The apparatus of claim 1, wherein the electrical circuitry further comprises program code utilized, at least in part, for determining whether said house is in close proximity to said user.

3. The device of claim 2, wherein determining whether said house is in close proximity to said user is done, at least in part, by using one or more parameters of the group consisting of: ambient temperature, accelerating parameters of the user, skin temperature of the user, tone of a user, spatial position of a detected object, spatial three-axis position of the detected object, noise, and sound.

4. The apparatus of claim 1, wherein the connecting unit comprises magnet unit configured to attract the metallic house.

5. The apparatus of claim 1, wherein the electrical circuitry is configured to communicate with a computerized device for receiving the electrical audio signal.

6. The apparatus of claim 1, wherein said electrical circuitry is configured for activate or deactivate the communication with the computerized device.

7. The apparatus of claim 6, wherein the electrical circuitry is configured for activate or deactivate the communication with the computerized device according to one or more predefined words.

8. The apparatus of claim 1, wherein the connector comprises a fastening mechanism for fastening the connector to the temple.

9. The apparatus of claim 8, wherein the fastening mechanism is at least two magnet modules each of which is connected to one of said wall, and wherein polarization of both magnetic modules is configured to attract the two magnetic modules to each other.
